(19) United States
(12) Patent Application Publication
(10) Pub. No.: US 2007/0120960 A1
(43) Pub. Date: May 31, 2007

(54) Portable electronic device with a rotatable camera module

(75) Inventor: Keng-Ming Chang, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/473,983

(22) Filed: Jun. 23, 2006

(30) Foreign Application Priority Data
Nov. 11, 2005 (CN) 200510101247.3

(51) Int. Cl. H04N 7/14

(52) U.S. Cl. 348/14.02

(57) ABSTRACT

An exemplary portable electronic device comprises a body (50), a camera module (90) and a rotatable component (70). The camera module is rotatably installed on the body. The rotatable component is rotatably mounted to the body. The camera module is installed in the rotatable component. Orientation of the camera module can be adjusted via rotating the rotatable component.

### TECHNICAL FIELD

The present invention relates to a portable electronic device with a rotatable camera module which can preview an object conveniently and can take photos from various angles.

### BACKGROUND

With the development of wireless communication and information processing, portable electronic devices, such as mobile telephones and personal digital assistants (PDAs), are now in widespread use. These electronic devices enable consumers to enjoy high technology services anytime and anywhere. The camera module has been an important member of portable electronic devices.

FIG. 1 shows a typical portable electronic device which is a mobile phone 30 including a keypad 31, a screen 33 and a camera module 35. The keypad 31 is defined in the face of the mobile phone 3 for inputting instructions. The screen 33 is also defined in the face of the mobile phone 30. The camera module 35 is defined in mobile phone 30 for taking photos. The camera module 35 includes a lens module 351 defined on the top surface or the back surface of the mobile phone 30.

When using the camera module 35 to take photos, an optical image signal enters the camera module 35 through the lens module 351. The optical image signal is focused on an image sensor module (not shown) and the image sensor module transforms the optical image signal into an electronic image signal that can be shown in the screen 33. However, the mobile phone 30 can only be used to screen objects in front of the lens module because light travels in a straight line. Therefore the mobile phone 30 can not easily to be used for screening objects departing from an axis of the lens module, and it is difficult to preview the picture when users use the mobile phone 30 to take a picture of themselves.

What is needed, therefore, is a portable electronic device with a camera module which can preview an object conveniently and can take photos from various angles.

### SUMMARY

In an embodiment thereof, a portable electronic device comprises a body, a camera module and a rotatable component. The camera module is rotatably installed on the body. The rotatable component is rotatably mounted to the body. The camera module is installed in the rotatable component. Orientation of the camera module can be adjusted via rotating the rotatable component.

Other advantages and novel features will become more apparent from the following detailed description when taken in conjunction with the accompanying drawings.

### BRIEF DESCRIPTION OF THE DRAWINGS

Many aspects of the portable electronic device can be better understood with reference to the following drawings. The components in the drawings are not necessarily drawn to scale, the emphasis instead being placed upon clearly illustrating the principles of the present portable electronic devices. Moreover, in the drawings, like reference numerals designate corresponding parts through out the several views.

FIG. 1 is an isometric view of a typical portable electronic device;

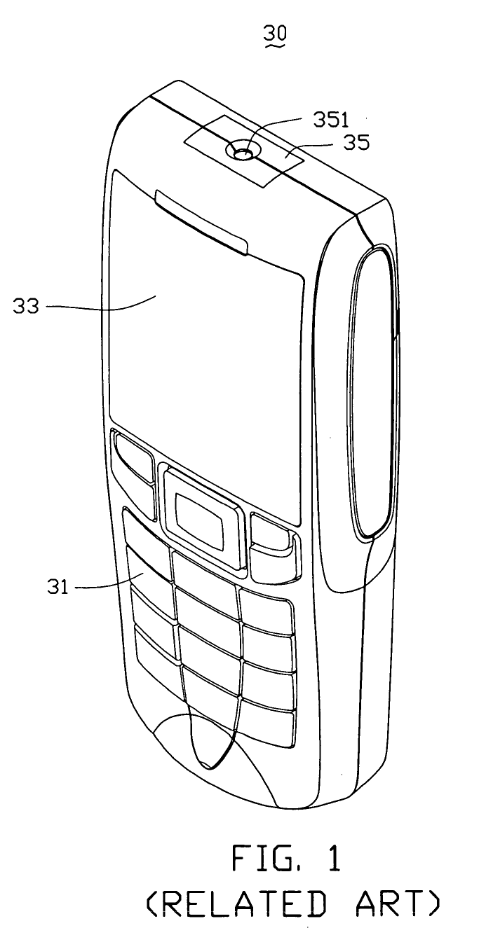

FIG. 2 is an isometric view of a portable electric device in accordance with a preferred embodiment of the present invention;

FIG. 3 is a partial isometric cut-away view of the portable electric device shown in FIG. 2;

FIG. 4 is a disassembled view of a rotatable component and a camera module of the portable electric device shown in FIG. 2 and FIG. 3; and

FIG. 5 is an assembled view of the rotatable component and the camera module shown in FIG. 4.

### DETAILED DESCRIPTION OF PERFERRED EMBODIMENTS

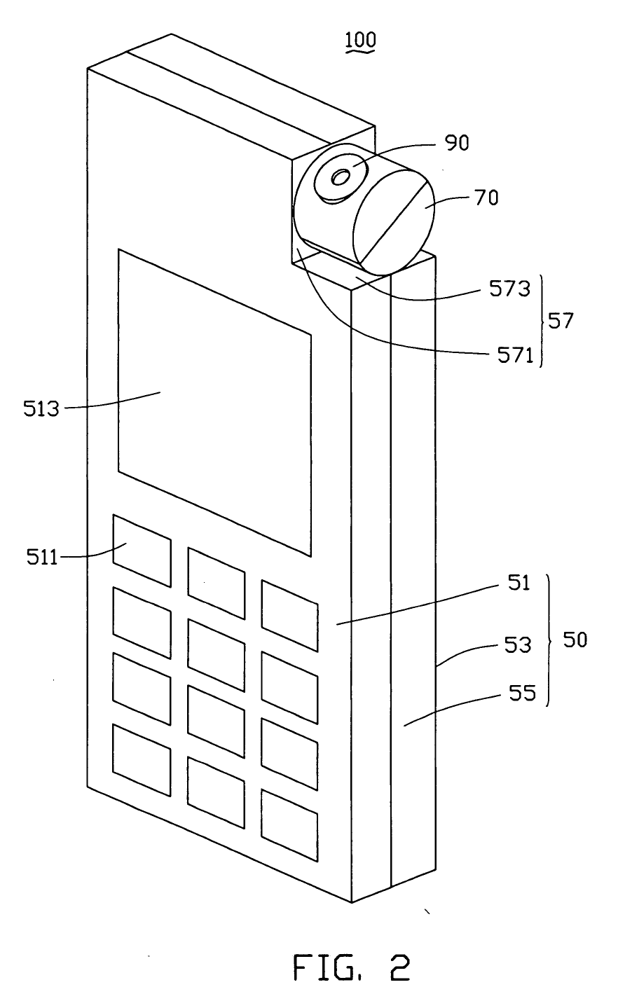

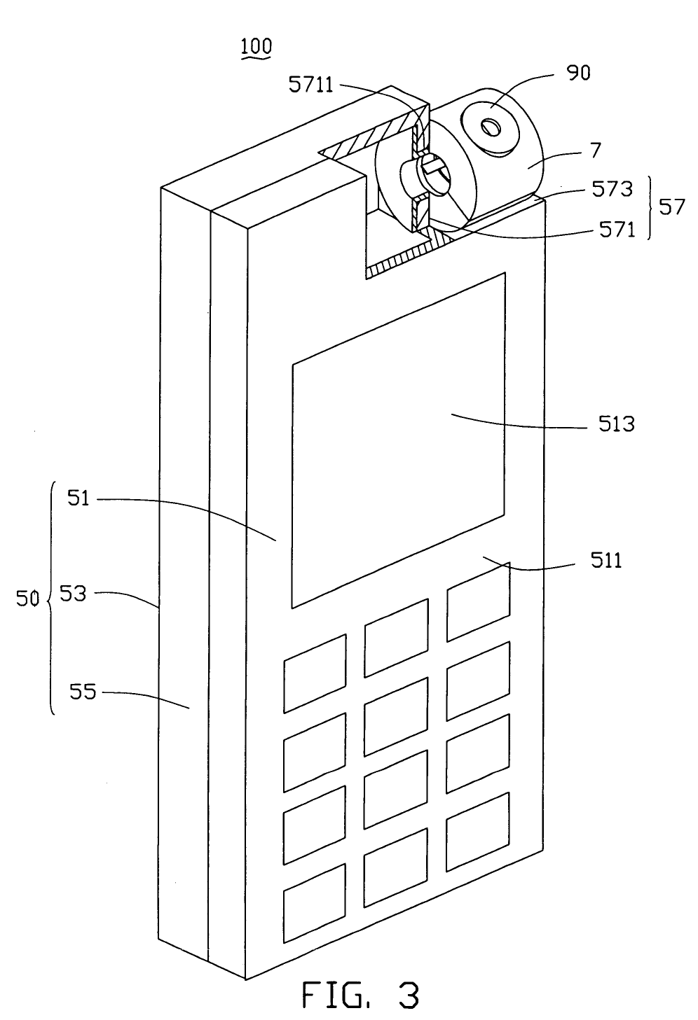

Referring now to the drawings, FIG. 2 shows a portable electronic device 100 according to a preferred embodiment of the present invention. The portable electronic device 100 is a mobile phone that includes a body 50, a rotatable component 70 and a camera module 90. The rotatable component 70 is rotatably installed on the body 50. The camera module 90 is securely installed in the rotatable component 70. Also referring to FIG. 3, the body 50 is a cuboid case that can be divided into two parts (not shown). The body 50 includes a first surface 51, a second surface 53 and four sides 55. The first surface 51 is positioned opposite to the second surface 53. The body 50 defines a rectangular cutout 57 through an intersection of two adjacent sides 55 thereby forming a first side wall 571 and a second side wall 573. The second side wall 573 is perpendicular to the first side wall 571. The first side wall 571 defines a fixing hole 5711 therein. Alternatively, the fixing hole 5711 can be defined in the second side wall 573.

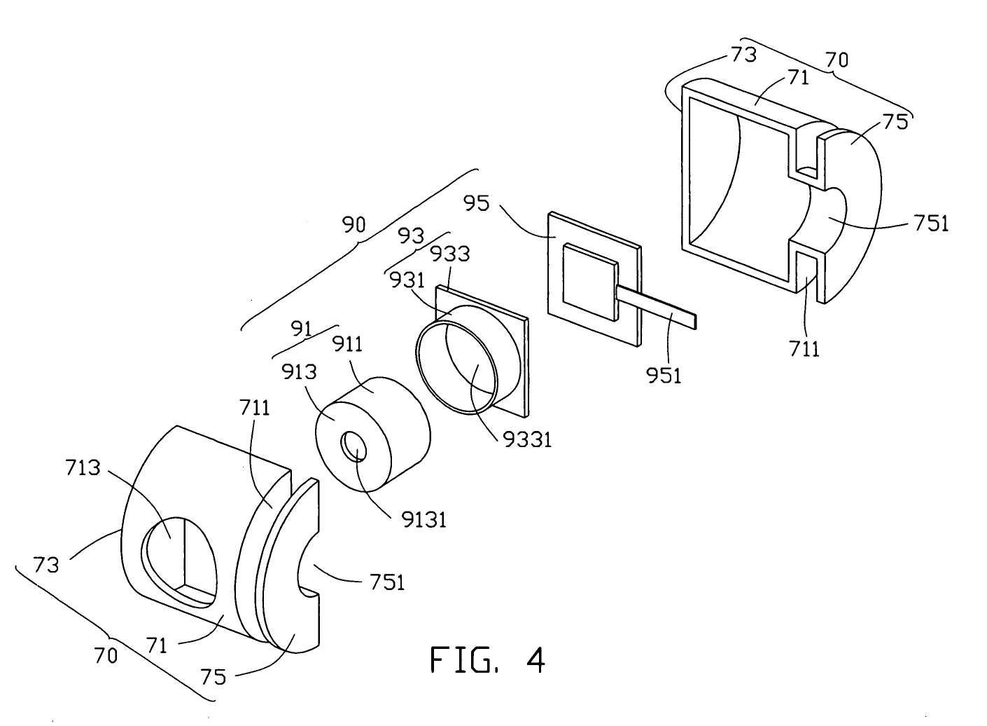

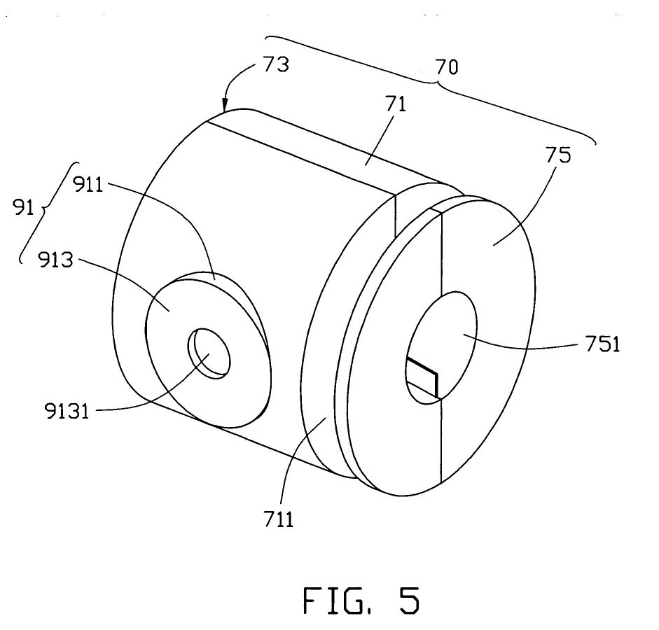

Referring to FIG. 4 and FIG. 5, the rotatable component 70 is a hollow cylinder that can be divided into two parts (not labeled). The rotatable component 70 includes a cylindrical housing 71, a closed off end 73 and a partly closed off end 75. The closed off end 73 is positioned opposite to the partly closed off end 75. A wire hole 751 is defined in the center of the partly closed off end 75. An annular groove 711 is defined around the housing 71, and the annular groove 711 is located adjacent to the partly closed off end 75. The housing 71 defines a lens hole 713 between the closed off end 73 and the partly closed off end 75 therein.

The camera module 90 installed in the rotatable component 70 includes a lens barrel 91, a holder 93 and an image sensor module 95. The lens barrel 91 is a cylinder including a sleeve barrel 911 and a cover 913. The sleeve barrel 911 is a cylinder and the cover 913 is a round board that partly closes off an end of the sleeve barrel 911. Some screw thread (not shown) is formed on an outer surface of the sleeve barrel 911. A plurality of lenses (not shown) are installed in the sleeve barrel 911. A first through hole 9131 is defined in the centre of the cover 913. The holder 93 is a cylinder with two open ends. The holder 93 includes a pipe 931 and a base 933. The base 933 is a board that defines a second through hole 9331 therein, and the diameter of the second through hole 9331 is same as the inner diameter of the pipe 931. The pipe 931 is installed on one side of the base 933 perpendicularly. Some screw thread (not shown) corresponding to the screw thread on the outer surface the sleeve barrel 911 is formed on an inner surface of the pipe 931. The lens barrel 91 is engaged to be installed in the pipe 931. The image sensor module 95 is installed on another side of the base 933 to transform optical image signals entering into the lens barrel 91 into electronic image signals. A signal wire 951 is installed on the image sensor module 95 and the signal wire 951 connects the image sensor module 95 with a circuit board (not shown) of the body 50. The signal wire 951 transmits electronic signals from the image sensor module 95 to the circuit board of the body 50.

In assembly, firstly, the lenses are installed in the sleeve barrel 911 of the lens barrel 91, and the lens barrel 91 is installed into the pipe 931 of the holder 93. The sleeve barrel 91 is adjusted to a proper place along an axis of the pipe 931 via the screw thread correspondingly formed on the outer surface of the sleeve barrel 911 and the inner surface of the pipe 931, thus the sleeve barrel 91 is held in the pipe 931. Secondly, the image sensor module 95 is installed on the base 933, and then the camera module 90 is assembled. Thirdly, the assembled camera module 90 is securely mounted into the rotatable component 70. The sleeve barrel 91 extends out from the lens hole 713 so that an incident light path of the camera module 90 is perpendicular to an axis of the housing 71. The signal wire 951 installed on the image sensor 95 extends out from the wire hole 751, and the two parts of the rotatable component 70 are coupled together. Finally, the rotatable component 70 containing the camera module 90 is rotatably mounted on the first side wall 571. The housing 71 cooperates with the fixing hole 5711 to hold the rotatable component 70 rotatably. The partly closed off end 75 is installed in the fixing hole 5711 and the closed off end 73 extends out from the fixing hole 5711. The first side wall 571 is engaged in the annular groove 711, and the two parts of the body 50 are connected. Alternatively, the second side wall 573 is engaged in the annular groove 711 if the fixing hole 5711 is defined in the second side wall 573. In this way, the rotatable component 70 can rotate around the axis of the housing 71 and cannot become separated from the first side wall 571, thus the camera module 90 is rotatably installed on the body 50 via the rotatable component 70.

In use, rotatable component 70 is rotated, and the camera module 90 installed in the rotatable component 70 is driven to rotate on the body 50. In this way, when using the camera module 90 to take photos, the user can rotate the rotatable component 70 to preview objects in various angles without rotating the body 50. The user can also rotate the rotatable component 70 to adjust orientation of the camera module 90 to screen himself conveniently. Alternatively, the portable electronic device 100 can be a PDA (personal digital assistant) or a laptop, etc.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A portable electronic device, comprising:
a body;
a rotatable component being installed on the body and being able to rotate around an axis thereof; and
a camera module whose incident light path is perpendicular to the axis being securely installed in the rotatable component.

2. The portable electronic device as claimed in claim 1, wherein the rotatable component includes a housing, the body defines a fixing hole therein, the housing cooperates with the fixing hole to hold the rotatable component rotatably.

3. The portable electronic device as claimed in claim 1, wherein the rotatable component is formed by two parts coupled together.

4. The portable electronic device as claimed in claim 2, wherein the housing is cylindrical and an annular groove is defined around the housing, a part of the body is engaged in the annular groove.

5. The portable electronic device as claimed in claim 4, wherein the rotatable component includes a closed off end and a partly closed off end, the closed off end is opposite to the partly closed off end; the partly closed off end is installed in the fixing hole and the closed off end extends out from the fixing hole.

6. The portable electronic device as claimed in claim 5, wherein the housing defines a lens hole between the closed off end and the partly closed off end therein.

7. The portable electronic device as claimed in claim 2, wherein the axis is an axis of the housing.

8. The portable electronic device as claimed in claim 1, wherein the camera module includes a lens barrel, a holder and an image sensor module; the lens barrel is installed in the holder, the image sensor module is installed on the holder.

9. The portable electronic device as claimed in claim 8, wherein the lens barrel includes a sleeve barrel and a cover; the cover partly closes off an end of the sleeve barrel, a plurality of lenses are installed in the sleeve barrel, and a through hole is defined in the centre of the cover.

10. The portable electronic device as claimed in claim 8, wherein the holder is a cylinder that includes a pipe and a base, the base is a board and the pipe is installed on one side of the base.

11. The portable electronic device as claimed in claim 10, wherein the lens barrel is installed in the pipe and the image sensor module is installed on another side of the base.

12. The portable electronic device as claimed in claim 8, wherein a signal wire is installed on the image sensor module, the signal wire connects the image sensor module with a circuit board of the body.

13. A portable electronic device, comprising:
a body;
a camera module being rotatably installed on the body; and
a rotatable component rotatably mounted to the body, the camera module being fixed in the rotatable component thus allowing orientation of the camera module to be adjusted via rotating the rotatable component.

14. The portable electronic device as claimed in claim 13, wherein the rotatable component includes a housing, the body defines a fixing hole therein, the housing cooperates with the fixing hole to hold the rotatable component rotatably.

15. The portable electronic device as claimed in claim 14, wherein the housing is cylindrical and an annular groove is defined around the housing, a part of the body is engaged in the annular groove.

16. The portable electronic device as claimed in claim 15, wherein the rotatable component includes a closed off end and a partly closed off end, the closed off end is opposite to the partly closed off end, the partly closed off end is installed in the fixing hole, and the closed off end extends out from the fixing hole.

17. The portable electronic device as claimed in claim 16, wherein the housing defines a lens hole between the closed off end and the partly closed off end therein.

18. The portable electronic device as claimed in claim 13, wherein the camera module includes a lens barrel, a holder and an image sensor module; the lens barrel is installed in the holder, the image sensor module is installed on the holder.

19. The portable electronic device as claimed in claim 18, wherein the lens barrel includes a sleeve barrel and a cover; the cover partly closes off an end of the sleeve barrel, a plurality of lenses are installed in the sleeve barrel, and a through hole is defined in the centre of the cover, wherein the holder is a cylinder that includes a pipe and a base, the base is a board and the pipe is installed on one side of the base.

20. The portable electronic device as claimed in claim 19, wherein the lens barrel is installed in the pipe and the image sensor module is installed on another side of the base, a signal wire is installed on the image sensor module, the signal wire connects the image sensor module with a circuit board of the body.
